(19) United States
(12) Patent Application Publication
(10) Pub. No.: US 2004/0117594 A1
(43) Pub. Date: Jun. 17, 2004

(54) Memory management method

(76) Inventor: Julius VanderSpek, San Jose, CA (US)

Correspondence Address: IP Counsel, Equator Technologies, Inc., 1300 White Oaks Road, Campbell, CA, 95008, US

(21) Appl. No.: 10/318,436

(22) Filed: Dec. 13, 2002

(51) Int. Cl. G06F 12/00

(52) U.S. Cl. 711/209; 711/170

(57) ABSTRACT

In a digital data processing system having a memory component, a method for managing available memory resources using a translation lookaside buffer (“TLB”) adapted to support at least two page sizes, 2^{M} and 2^{M+N}, where M and N are both integers. Each time an active process is allocated a page of memory of size 2^{M}, an attempt is made to construct a larger cluster of size 2^{M+N} from currently-mapped pages. Clustering will be possible if and only if all 2^{N} of the logical pages having logical page addresses of the form L[st]{x:x} are either currently-mapped or currently being mapped, where s and t are the same for all 2^{N} of the logical pages but {x:x} can be any of the 2^{N} possible different combinations and permutations of “0” and “1”. As a result of clustering, a single translator is used to map the entire cluster of 2^{N} pages and (2^{N}−1) translators are made available for mapping other pages. If the TLB is capable of supporting even larger page sizes, clustering can be attempted recursively.

### BACKGROUND OF THE INVENTION

1. Technical Field

The present invention relates generally to digital data processing systems, and, in particular, to methods in digital data processing systems for managing memory resources.

2. Background Art

In general, in the descriptions that follow, I will italicize the first occurrence of each special term of art which should be familiar to those skilled in the art of digital data processing systems. In addition, when I first introduce a term that I believe to be new or that I will use in a context that I believe to be new, I will bold the term and provide the definition that I intend to apply to that term. Since my invention is specifically intended for use in digital data processing systems, I will often use terms that are well known to those skilled in this particular art. For example, some of the common terms of art that I may use include: b for bit and B for byte, msb for most significant bit and Isb for least significant bit; and MB for megabyte.

Shown by way of example in FIG. 1 is a conventional data processing system 2, consisting primarily of a central processing unit or CPU 4 and a memory 6. From the perspective of the CPU 4, the limited physical address space within the memory 6 is viewed as an unlimited logical address space. A translation lookaside buffer or TLB 8 is provided to dynamically translate each logical address provided by the CPU 4 into a corresponding one of the physical addresses required by the memory 6. To facilitate this translation process, the logical addresses provided by the CPU 4 are partitioned into a logical page number 10 and a page offset 12. The TLB 8 dynamically translates the logical page number 10 into a corresponding physical page number 14. By way of example, if the data processing system 2 is adapted to use the popular 32-bit addressing scheme, the page offset might comprise the M low order address bits and the upper (32-M) address bits would comprise the logical/physical page number.

Typically, the operating system or OS, executing on the CPU 4, builds and maintains, for each active process, a set of page tables containing essential information pertaining to each of the logical pages comprising that process. For example, a typical page table entry will indicate whether or not the corresponding page is currently resident in the memory 6 and, if not, where that page can be found on a long term storage device, such as a hard disk device (not shown). When an active process executing on the CPU 4 first issues a logical address within a particular one of its logical pages, the TLB 8 will lack the necessary translation information to effect the required translation, and so will signal a page fault. In response, the OS will activate a memory management process to perform a series of related tasks: first, to locate, using the faulting process' page tables, the requested page on the long term storage device; second, to allocate a portion of the available space in the memory 6 sufficient to hold the requested page; third, to transfer or load from long term storage the requested page into the allocated space in the memory 6; and, finally, to load the required logical-to-physical page translation information into one of a limited set of translator entries in the TLB 8. If successful, the memory management process can then restart the faulting access of the active process; since the TLB 8 now contains a corresponding translator, the active process will proceed with normal execution without immediately experiencing another page fault.

During subsequent operation, the memory management process may be required to temporarily store or roll out to long term storage a once-memory-resident page in order to make room in the memory 6 for a different page of the same active process or, perhaps, a page of a different, but simultaneously active process. Since this process of dynamically sharing the available physical memory is essentially transparent to each of the active processes, the system is often referred to as having a virtual memory. Thus, from the perspective of each active process, the system appears to have an unlimited amount of available memory, albeit it there may be some non-deterministic delay in gaining access to selected pages in the virtual memory space. Significant efforts have been, and continue to be, devoted to minimizing, not just the duration of this delay, but also the frequency of its occurrence. Often, the perceived performance of the system as a whole is strongly correlated with how effectively the system accomplishes this task.

In general, memory access patterns vary greatly between applications. In some, for example, the majority of accesses are restricted to a relatively small number of pages, whereas in others, accesses are spread more or less evenly across a significant number of pages. The latter, sometimes characterized as having large working sets, frequently encounter page faults if the system has insufficient resources to simultaneously accommodate the entire working set of logical pages. This problem becomes particularly acute in systems in which other processes are simultaneously active and exerting additional demands upon the memory resources. In any event, given that neither the size of the memory 6 nor the number of translators in the TLB 8 is unlimited, most applications can be expected to experience at least some level of performance degradation during periods of high processing activities.

A modern data processing system can typically support more than one page size, each a different (but still integral) power of 2. For example, in the data processing system 2, the TLB 8 might be able to support a first page size of 2^{M} and an 2^{N}-times-larger second page size of 2^{M+N}. If M were, say, 14, then the first page size would comprise 16,384 B, and if N were, for example, 2, then the second page size would comprise 65,536 B. However, not all operating systems are adapted to exploit this flexibility. For example, the popular Linux® OS typically uses a fixed page size of 2¹² (4,096 B), and is, as presently designed, incapable of dynamically varying page size. For those applications having large working sets, this OS restriction becomes particularly problematic in the context of a system capable of supporting significantly larger page sizes.

Shown by way of example in FIG. 2 through FIG. 5 are the steps used in a convention prior art memory management process executing on the data processing system 2 for mapping a set of logical pages to a respective set of physical pages, wherein each page is of size 2^{M}. For convenience of reference, I shall designate logical page numbers using the following syntax: L[st]{n:n}, where L designates the page as belonging to the logical address space, s comprises the S msb of the logical page number the values of which are of no particular significance to this explanation, t comprises the (N+1)^{st} lsb of the logical page number, and {n:n} comprise the N lsb of the logical page number. Similarly, I shall designate physical page numbers using the following syntax: P[uv]{n:n}, where P designates the page as belonging to the physical address space, u comprises the U msb of the physical page number the values of which are of no particular significance to this explanation, v is the (N+1)^{st} lsb of the physical page number, and {n:n} comprise the N lsb of the physical page number. In each case, the brackets “[ ]” enclose bits of the page number that are dynamically mapped but only the lsb of which is relevant to this explanation. Whenever in the examples to follow it is possible for me to show all N lsb of a given page number, I shall do so directly without the enclosing brace structure “{:}”. With respect to the translators in the TLB 8, I shall indicate the size of the corresponding physical page in an appended size field as a relative power of 2, e.g., “M” indicates that the size of the page is 2^{M}. All inactive translators I shall designate as “L_” with a size field of “0”.

Note: In order not to unnecessarily complicate the following explanation, I will assume that the active process consists of only 4 logical pages, the memory 6 has only 8 physical pages available for use, and the TLB 8 can accommodate only 4 translators. However, in a real system, both the TLB 8 and, in particular, the memory 6 can be expected to be significantly larger.

In the first step, shown in FIG. 2, an active process, say, Process_A, first attempts to access an address within a first logical block L[s1]00. Since the TLB 8 does not as yet contain a corresponding translator, a page fault results. In response, the memory management process will be activated to perform the following steps: first, it locates, using Process_A's page tables, the requested page on the long term storage device; second, it allocates a portion of the available space in the memory 6 sufficient to hold the requested page, in this case selecting the physical page P[u1]01; third, it loads from long term storage the requested page into the allocated page; and, finally, it loads the required logical-to-physical page translation information into the first translator slot in the TLB 8. In this case, it is only by coincidence that the 3rd lsb (i.e., the v bit) of the physical page number matches the corresponding bit (i.e., the t bit) of the logical page number.

In the second step, shown in FIG. 3, Process_A first attempts to access an address within a second logical block L[s1]01. Since the TLB 8 does not as yet contain a corresponding translator, a page fault results. In response, the memory management process will be activated to perform the following steps: first, it locates, using Process_A's page tables, the requested page on the long term storage device; second, it allocates a portion of the available space in the memory 6 sufficient to hold the requested page, in this case selecting the physical page P[u0]00; third, it loads from long term storage the requested page into the allocated page; and, finally, it loads the required logical-to-physical page translation information into the second translator slot in the TLB 8. Notice that, in this case, the 3rd lsb (i.e., the v bit) of the physical page number does not happen to match the corresponding bit (i.e., the t bit) of the logical page number.

In the third step, shown in FIG. 4, Process_A first attempts to access an address within a third logical block L[s1]11. Since the TLB 8 does not as yet contain a corresponding translator, a page fault results. In response, the memory management process will be activated to perform the following steps: first, it locates, using Process_A's page tables, the requested page on the long term storage device; second, it allocates a portion of the available space in the memory 6 sufficient to hold the requested page, in this case selecting the physical page P[u0]01; third, it loads from long term storage the requested page into the allocated page; and, finally, it loads the required logical-to-physical page translation information into the third translator slot in the TLB 8. As in the second case, the 3rd lsb (i.e., the v bit) of the physical page number does not happen to match the corresponding bit (i.e., the t bit) of the logical page number.

Finally, in the fourth step, shown in FIG. 5, Process_A first attempts to access an address within a fourth logical block L[s1]10. Since the TLB 8 does not as yet contain a corresponding translator, a page fault results. In response, the memory management process will be activated to perform the following steps: first, it locates, using Process_A's page tables, the requested page on the long term storage device; second, it allocates a portion of the available space in the memory 6 sufficient to hold the requested page, in this case selecting the physical page P[u0]00; third, it loads from long term storage the requested page into the allocated page; and, finally, it loads the required logical-to-physical page translation information into the fourth and last translator slot in the TLB 8. Again, by coincidence, the 3rd lsb (i.e., the v bit) of the physical page number matches the corresponding bit (i.e., the t bit) of the logical page number.

From this point of time onward, any page fault (or, indeed, any routine process request for allocation for additional memory) will result in at least one of the currently mapped physical pages being rolled out to long term storage to make room in the TLB 8 for the required translators. Since in this example there are clearly additional free blocks available in the memory 6, this consequence is a directly attributable to having insufficient resources in the TLB 8 itself. If the set of mapped logical pages happen to be scattered (i.e., they differ in more than the 2 lsb for the illustrated example), there may be no way to avoid the resultant thrashing. However, if, as in the example I have just described, the set of logical pages are logically contiguous and, as a block, are aligned on a suitable logical boundary, it is possible to construct the system so as to use a larger page size, so that each translator maps a significantly larger portion of the logical address space. Unfortunately, the only prior art solutions of which I am aware are static in operation, requiring the system to select the size of each page at load time. As such, such solutions are incapable of dynamically adjusting the size of previously-loaded pages so as to minimize page faults. Furthermore, as I pointed out above, some operating systems, such and Linux®, are incapable of exploiting any such facility even if it were to be available!

I submit that what is needed is a more efficient method for managing available memory resources, and, in particular, one in which the translators in the TLB are dynamically managed in a way that is largely transparent to the operating system yet minimizes page faults.

### SUMMARY OF THE INVENTION

In accordance with a preferred embodiment of my invention, I provide a method for managing a virtual memory system adapted to support at least two page sizes, 2^{M} and 2^{M+N}, where M and N are both integers. In response to a request to allocate a page of memory of size 2^{M}, I initially determine if it possible to cluster by 2^{N}. If I determine that clustering is not possible, I simply allocate a first page of memory size 2^{M}. However, if I determine that clustering is possible, I first allocate a staging page of memory of size 2^{M+N+1}, the staging page comprising 2^{N+1} contiguous second pages of memory each of size 2^{M}. I then assemble into respective ones of a contiguous subset of 2^{N} of the second pages of the staging page the contents of at most 2^{N} of the first pages, thereby forming a cluster of size 2^{M+N} and leaving unused the remaining 2^{N} second pages of the staging page. Finally, I deallocate from the staging page said 2^{N} unused second pages. In general, clustering will be possible if and only if all 2^{N} of the first pages having logical page addresses of the form L[st]{x:x} are either currently-allocated or currently being allocated, where s and t are the same for all 2^{N} of the first pages but {x:x} can be any of the 2^{N} possible different combinations and permutations of “0” and “1”. Preferably, upon the assembly of the contents of a selected one of said first pages into the respective one of the second pages of the staging page, I deallocate the selected first page.

In a second embodiment of my invention, I provide a method for managing a virtual memory system adapted to support small pages and large pages, the large pages being twice the size of the small pages. In response to a request to allocate a first one of the small pages, I initially determine if it possible to cluster the first small page with an allocated second one of the small pages. If I determine that clustering is not possible, I simply allocate the first small page. However, if I determine that clustering is possible, I first allocate a large page on a selected boundary in the memory. I then assemble into the large page the contents of the first and second small pages. In general, clustering will be possible if the first and second small pages are logically contiguous.

In another embodiment of my invention, I provide a method for managing a virtual memory system adapted to support first and second page sizes, where the second page size is a first integer multiple N of the first page size. In response to a request to allocate a page of memory of the first size, I initially determine if it possible to cluster by N. If I determine that clustering is not possible, I simply allocate in the memory a first page of the first size. However, if I determine that clustering is possible, I allocate on a selected boundary in the memory a second page of the second size. I then assemble into this second page the contents of up to N of the first pages. In general, clustering is possible if, among the allocated first pages, there are at least a minimum number of logically-contiguous pages. Preferably, N is an integer power of 2.

In yet another embodiment of my invention, I provide a method for managing a virtual memory system adapted to support first and second page sizes, where the second page size is a first integer multiple N of the first page size. In response to a request to allocate a page of memory of the first size, I initially determine if it possible to cluster by N. If I determine that clustering is not possible, I simply allocate a page of memory of the first size. However, if I determine that clustering is possible, I first allocate a staging page of memory of the second size, the staging page comprising 2^{N} contiguous pages of memory each of the first size. I then assemble into the staging page a cluster of N pages of memory each of the first size. Finally, I deallocate from the staging page the N unused pages of the first size. In general, clustering is possible if and only if there are at least a minimum number of logically-contiguous pages of the first size currently allocated in the memory. Preferably, N is an integer power of 2.

### BRIEF DESCRIPTION OF THE SEVERAL VIEWS OF THE DRAWINGS

My invention may be more fully understood by a description of certain preferred embodiments in conjunction with the attached drawings in which:

FIG. 1 is a block representation of a conventional data processing system in which logical addresses issued by a CPU component are dynamically translated by a TLB into physical addresses required by a memory component;

FIG. 2 is a block representation of a first step in the process of mapping a set of logical pages to a respective set of physical pages, using a prior art memory management process on the system of FIG. 1;

FIG. 3 is a block representation of a second step in the process of mapping a set of logical pages to a respective set of physical pages, using a prior art memory management process on the system of FIG. 1;

FIG. 4 is a block representation of a third step in the process of mapping a set of logical pages to a respective set of physical pages, using a prior art memory management process on the system of FIG. 1;

FIG. 5 is a block representation of a fourth step in the process of mapping a set of logical pages to a respective set of physical pages, using a prior art memory management process on the system of FIG. 1;

FIG. 6 is a flow chart illustrating generally the steps of the preferred embodiment of my new page clustering technique as it may be practiced in the context of a conventional memory management process on the system of FIG. 1;

FIG. 7 is a block representation of a first step in a process of clustering the set of logical pages into a single, larger physical page, using my new memory management process on the system of FIG. 1;

FIG. 8 is a block representation of a second step in the process of clustering the set of logical pages into a single, larger physical page, using my new memory management process on the system of FIG. 1;

FIG. 9 is a block representation of a third step in the process of clustering the set of logical pages into a single, larger physical page, using my new memory management process on the system of FIG. 1;

FIG. 10 is a block representation of a fourth step in the process of clustering the set of logical pages into a single, larger physical page, using my new memory management process on the system of FIG. 1; and

FIG. 11 is a block representation of fifth and last step in the process of clustering the set of logical pages into a single, larger physical page, using my new memory management process on the system of FIG. 1.

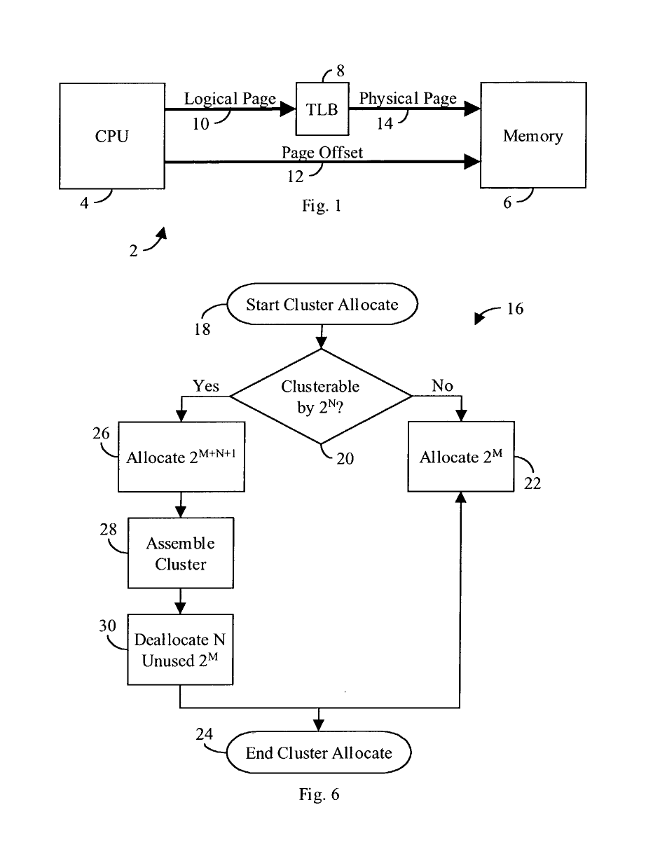

In the drawings, similar elements will be similarly numbered whenever possible. However, this practice is simply for convenience of reference and to avoid unnecessary proliferation of numbers, and is not intended to imply or suggest that my invention requires identity in either function or structure in the several embodiments.

### DETAILED DESCRIPTION OF THE INVENTION

In accordance with the preferred embodiment of my invention, I manage available memory resources by a process I refer to as opportunistic page clustering. In general, my invention can be applied in the data processing system 2 if the TLB 8 is capable of supporting at least two page sizes, say, 2^{M} and 2^{M+N}, where M and N are both integers. Furthermore, if the TLB 8 is capable of supporting even larger page sizes, clustering can be attempted recursively.

As shown generally in FIG. 6, my clustering technique will be attempted by the memory management process during the course of servicing not only each page fault but also each routine request for allocation of a memory block. Upon activation of my cluster allocation process 16 (block 18), the memory management process must first determine if it is possible to cluster by 2^{N} (block 20). As I shall demonstrate below, clustering will be possible if and only if all 2^{N} of the logical pages having logical page addresses of the form L[st]{x:x} are either currently-mapped or currently being mapped, where s and t are the same for all 2^{N} of the logical pages but {x:x} can be any of the 2^{N} possible different combinations and permutations of “0” and “1”.

If clustering is not possible, my cluster allocation process 16 will proceed substantially as in the prior art to allocate a physical page of size 2^{M} and load the corresponding translator into a slot in the TLB 8 (block 22). If a slot is not available, the process must select and then roll out to memory a currently-mapped page to make room in the TLB 8 for the new descriptor. If successful, the process will then terminate normally (block 24).

If clustering is possible, however, my cluster allocation process 16 will proceed to allocate a staging page of size 2^{M+N+1} and load the corresponding translator into a slot in the TLB 8 (block 26). If either a slot is not available in the TLB 8 or a physical page of this size is not available for allocation in the memory 6, the process will select and roll out to memory just enough currently-mapped pages to make room for the staging page. Once obtained, the process will then assemble all of the scattered N components into a contiguous set of N of the 2^{N} pages of size 2^{M} that comprise the staging page (block 28); the result is a single, unified cluster of size 2^{M+N}, properly aligned on the appropriate 2^{M+N} boundary. During this step, as each component of the cluster is successfully copied from its then-current location somewhere in the physical space to its new location within the staging page, the process will deallocate the originally allocated physical space and release all but one of the respective translators in the TLB 8. Once the cluster is complete, there will be N unused pages, each of page size 2^{M}, of the original 2^{N} pages comprising the staging page; these the process will simply deallocate (block 30). The process will then terminate normally (block 24). Thus, as a result of my clustering technique, the N translators required by the prior art process to map N pages of size 2^{M} can be dynamically replaced by a single translator which maps a single page of size 2^{M+N}, thereby releasing critical TLB 8 resources for other uses.

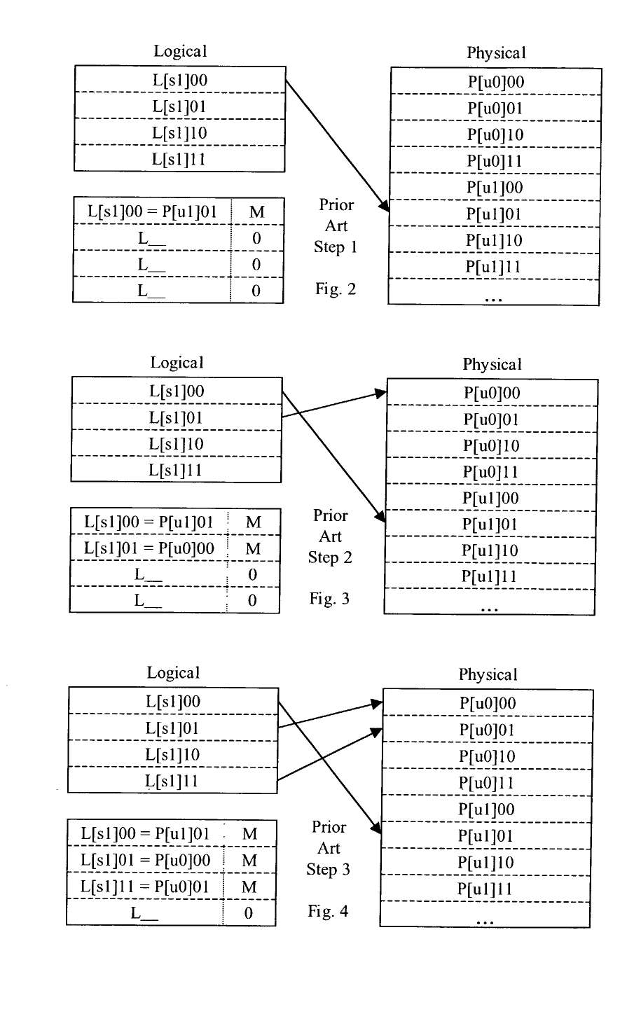

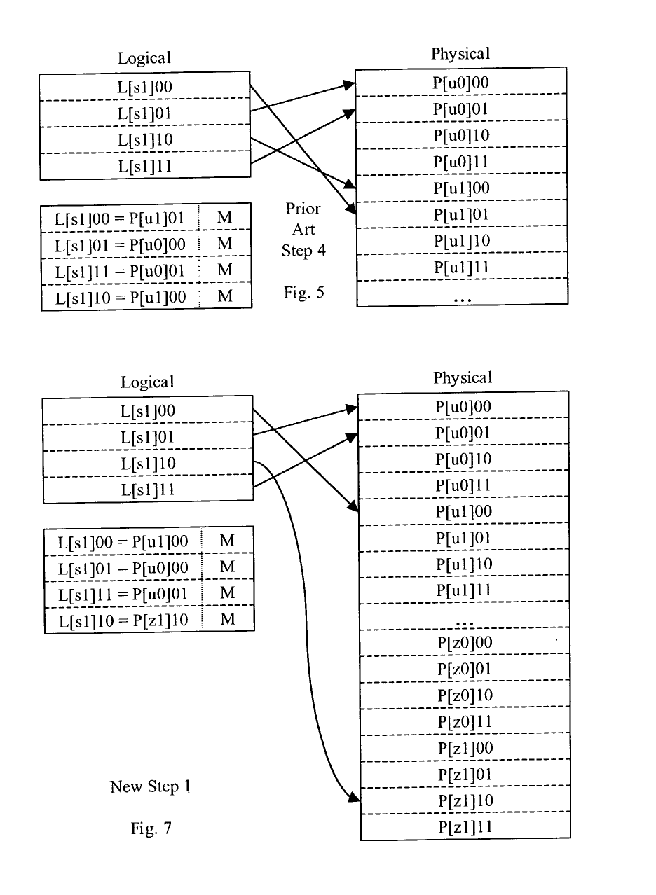

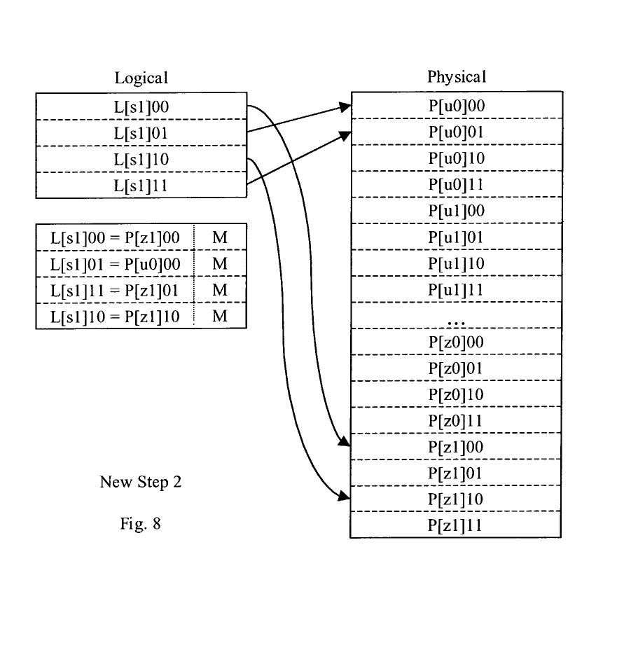

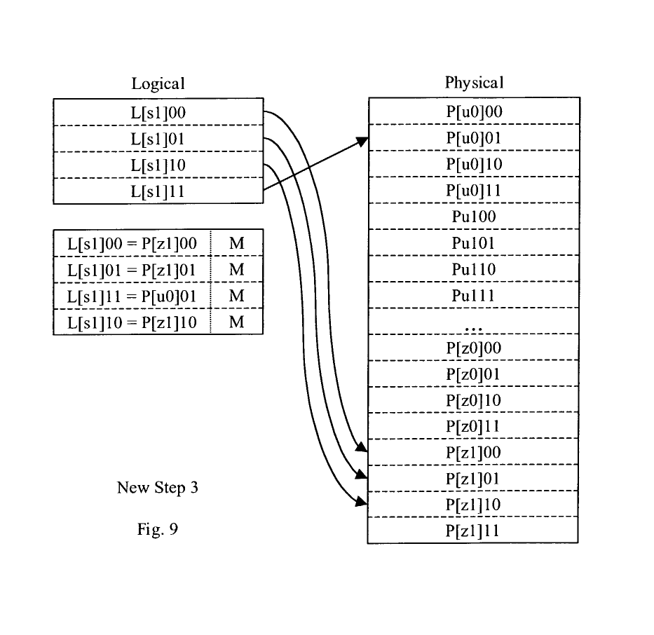

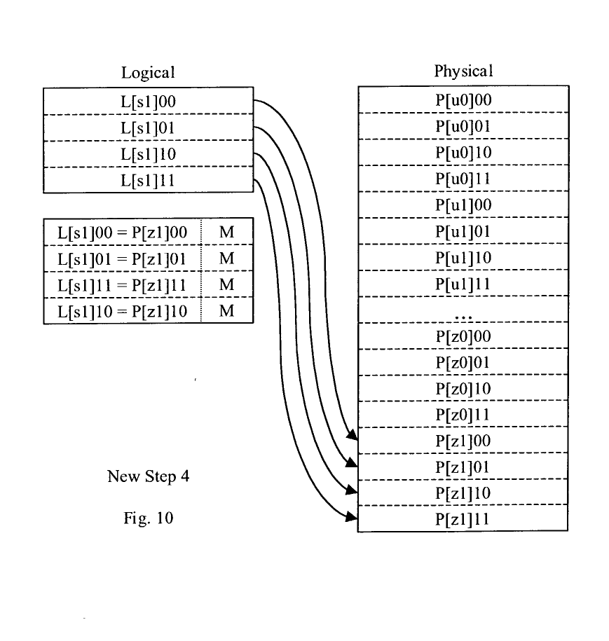

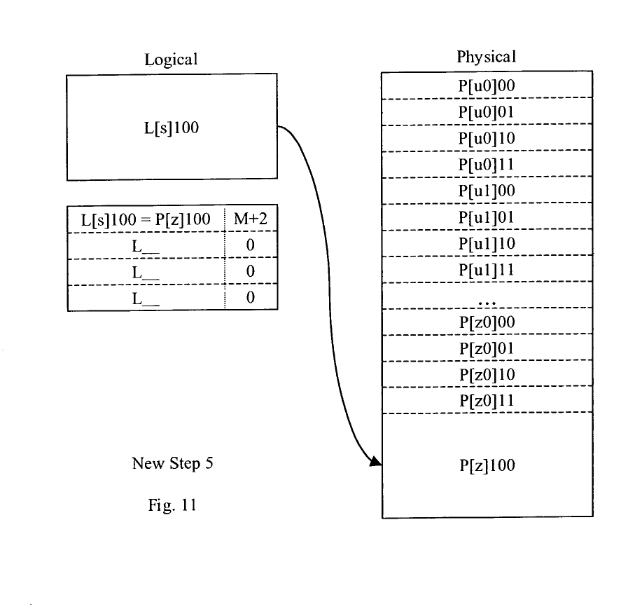

For convenience of illustrating the operation of my cluster allocation process 16, let me assume that Process_A again attempts to access its logical pages in the same sequence shown in FIG. 2 through FIG. 5. For each of the accesses illustrated in FIG. 2 through FIG. 4, the conditions necessary for clustering will not exist, and my cluster allocation process 16 will produce substantially the same results as those illustrated. However, once Process_A attempts to access the fourth logical block L[s1]10 (see, generally, FIG. 5), the conditions necessary and sufficient for clustering will exist, i.e., 3 of the 4 logical pages (namely, L[s1]00, L[s1]01, and L[s1]11) comprising the cluster L[s1]xx are already mapped into the memory 6, and the 4th and last logical page of this cluster (namely, L[s1]10) is currently being mapped. At this point, unlike the results produced by the prior art process as shown in FIG. 5, my cluster allocation process 16 will perform a new step 1 (see, FIG. 7) in which a staging page L[zx]xx is allocated and the logical page L[s1]10 mapped directly into the appropriate location, L[z1]10 within the staging page. Then, in new steps 2 (FIG. 8), 3 (FIG. 9) and 4 (FIG. 10), the other 3 components of the cluster are moved from their pre-existing locations in the memory 6 to the proper locations within the staging page. Thus, by the end of new step 4, as shown in FIG. 10, logical page L[s1]00 is mapped into physical page P[z1]00, logical page L[s1]01 is mapped into physical page P[z1]01, logical page L[s1]10 is mapped into physical page P[z1]10, and logical page L[s1]11 is mapped into physical page PF[z1]11. Now, in new step 5, shown in FIG. 11, the translator in the TLB 8 that has used up to this point to map logical page L[s1]00 to physical page P[z1]00 can be modified to map the logical page L[s]100 to physical page P[z]100, simply by changing the page size selector of the translator from M to (M+2). Since the entire cluster is now mapped using a single translator, the other 3 translators can now be released (e.g., by having their page size selectors set to 0).

In a second embodiment of my invention, I provide a method for managing a virtual memory system adapted to support small pages and large pages, the large pages being twice the size of the small pages. In response to a request to allocate a first one of the small pages, I initially determine if it possible to cluster the first small page with an allocated second one of the small pages. If I determine that clustering is not possible, I simply allocate the first small page. However, if I determine that clustering is possible, I first allocate a large page on a selected boundary in the memory. I then assemble into the large page the contents of the first and second small pages. In general, clustering will be possible if the first and second small pages are logically contiguous.

In a more general sense my invention can be viewed as a method for managing a virtual memory system adapted to support first and second page sizes, where the second page size is a first integer multiple N of the first page size. In this embodiment, as in my preferred embodiment, in response to a request to allocate a page of memory of the first size, I initially determine if it possible to cluster by N. If I determine that clustering is not possible, I simply allocate in the memory a first page of the first size. However, in this embodiment, if I determine that clustering is possible, I allocate on a selected boundary in the memory a second page of the second size. I then assemble into this second page the contents of up to N of the first pages. In general, in this embodiment, clustering is possible if, among the allocated first pages, there are at least a minimum number of logically-contiguous pages. Preferably, N is an integer power of 2.

From yet another perspective my invention can be viewed as a method for managing a virtual memory system adapted to support first and second page sizes, where the second page size is a first integer multiple N of the first page size. In this embodiment, as in my preferred embodiment, in response to a request to allocate a page of memory of the first size, I initially determine if it possible to cluster by N. If I determine that clustering is not possible, I again allocate a page of memory of the first size. However, in this embodiment, if I determine that clustering is possible, I first allocate a staging page of memory of the second size, wherein the staging page is comprised of 2^{N} contiguous pages of memory each of the first size. I then assemble into the staging page a cluster of N pages of memory each of the first size. Finally, I deallocate from the staging page the N unused pages of the first size. In general, in this embodiment, clustering is possible if there are at least a minimum number of logically-contiguous pages of the first size currently allocated. Preferably, N is an integer power of 2.

Thus it is apparent that I have provided a method for efficiently managing available memory resources. In particular, I have disclosed several methods for opportunistically clustering scattered pages of size 2^{M} into single contiguous pages of size 2^{M+N}. In general, all of my methods are recursive and can be used to opportunistically create increasingly larger clusters, thereby improving memory efficiency. Those skilled in the art will recognize that modifications and variations can be made without departing from the spirit of my invention. Therefore, I intend that my invention encompass all such variations and modifications as fall within the scope of the appended claims.

What I claim is:

1. A method for managing a virtual memory system adapted to support at least two page sizes, 2^{M} and 2^{M+N}, where M and N are both integers, the method comprising:
in response to a request to allocate a page of memory of size 2^{M}, determining if it possible to cluster by 2^{N};
if clustering is not possible, allocating a first page of memory size 2^{M}; and
if clustering is possible:
allocating a staging page of memory of size 2^{M+N+1}, said staging page comprising 2^{N+1} contiguous second pages of memory each of size 2^{M};
assembling into respective ones of a contiguous subset of 2^{N} of said second pages of said staging page the contents of at most 2^{N} of said first pages, thereby forming a cluster of size 2^{M+N} and leaving unused the remaining 2^{N} second pages of said staging page; and
deallocating from the staging page said 2^{N} unused second pages.

2. The method of claim 1 wherein clustering is possible if and only if all 2^{N} of the first pages having logical page addresses of the form L[st]{x:x} are either currently-allocated or currently being allocated, where s and t are the same for all 2^{N} of the first pages but {x:x} can be any of the 2^{N} possible different combinations and permutations of “0” and “1”.

3. The method of claim 1 wherein the step of assembling further comprises:
upon the assembly of the contents of a selected one of said first pages into the respective one of said second pages of the staging page, deallocating said selected first page.

4. A method for managing a virtual memory system adapted to support small pages and large pages, the large pages being twice the size of the small pages, the method comprising:
in response to a request to allocate a first one of said small pages, determining if it possible to cluster said first small page with an allocated second one of said small pages;
if clustering is not possible, allocating said first small page; and
if clustering is possible:
allocating a large page on a selected boundary in said memory; and
assembling into said large page the contents of said first and second small pages.

5. The method of claim 4 wherein clustering is possible if said first and second small pages are logically contiguous.

6. A method for managing a virtual memory system adapted to support first and second page sizes, where the second page size is a first integer multiple N of the first page size, the method comprising:
in response to a request to allocate a page of memory of said first size, determining if it possible to cluster by N;
if clustering is not possible, allocating in said memory a first page of said first size; and
if clustering is possible:
allocating on a selected boundary in said memory a second page of said second size; and
assembling into said second page the contents of up to N of said first pages.

7. The method of claim 6 wherein clustering is possible if, among the allocated first pages, there are at least a minimum number of logically-contiguous pages.

8. The method of claim 6 wherein N is an integer power of 2.

9. A method for managing a virtual memory system adapted to support first and second page sizes, where the second page size is a first integer multiple N of the first page size, the method comprising:
in response to a request to allocate a page of memory of said first size, determining if it possible to cluster by N;
if clustering is not possible, allocating a page of memory of said first size; and
if clustering is possible:
allocating a staging page of memory of said second size, said staging page comprising 2^{N} contiguous pages of memory each of said first size; and
assembling into said staging page a cluster of N pages of memory each of said first size; and
deallocating from the staging page the N unused pages of said first size.

10. The method of claim 9 wherein clustering is possible if and only if there are at least a minimum number of logically-contiguous pages of said first size currently allocated in said memory.

11. The method of claim 9 wherein N is an integer power of 2.
